(19) United States
(12) Patent Application Publication
(10) Pub. No.: US 2006/0207393 A1
(43) Pub. Date: Sep. 21, 2006

(54) Wrench

(76) Inventor: Joe A. Stupar, Ramona, CA (US)

Correspondence Address: Thomas J. Tighe, Esq., Suite 103, 6265 Greenwich Drive, San Diego, CA, 92122, US

(21) Appl. No.: 11/083,906

(22) Filed: Mar. 17, 2005

(51) Int. Cl. B25B 23/16; B25G 1/04

(52) U.S. Cl. 81/177.75; 81/177.2

(57) ABSTRACT

A wench includes a head of jaws for engaging an item being wrenched driven by a handle that when rotated axially wrenchingly turns the head about said item. The handle is universally articulated intermediate the head and a distal end of the handle. Preferably the handle of the wrench is adjustable in length. Preferably the handle includes a fore segment and an aft segment serially universally jointed.

### BACKGROUND OF THE INVENTION

This invention relates in general to wrenches that are often referred to as “basin” wrenches, and in particular to such a wrench having a handle that is telescopingly adjustable in length and that is universally jointed intermediate the wrench head and its end distal from the head.

The prior art shows basin wrenches having a telescoping handle for length adjustment but absent from the prior art is a basin wrench with a universally articulated handle. An example of a conventional basin wrench is presented in FIG. 1 of U.S. Pat. No. 4,485,702 by Swan et al. Since the jaw head pivots, the wrench can be operated with the handle angled somewhat away from a fitting being operated upon. However, the work area beneath a basin is most often very cramped and the plumbing fixtures are often difficult to reach or are block by the various pipes and tubes typically found under basins. There often arises a situation in which simply angling the wrench's handle does not give enough clearance to operate the wrench. This invention's articulated handle provides a great advantage because the handle can be folded around obstructions to obtain clearance necessary to operate it.

Other advantages and attributes of this invention will be readily discernable upon a reading of the text hereinafter.

### SUMMARY OF THE INVENTION

An object of this invention is to provide a wrench with an axially rotatable handle that can be folded around obstructions but yet still be operational.

A further object of this invention is to provide a basin-type wrench including a universally articulated handle.

A further object of this invention is to provide a basin-type wrench with a universally articulated, telescopically adjustable handle.

These objects, and other objects expressed or implied in this document, are accomplished by a wench comprising: a head including jaws for engaging an item being wrenched; and a handle that when rotated axially wrenchingly turns the head about said item, the handle being universally articulated intermediate the head and a distal end of the handle. Preferably the handle of the wrench is adjustable in length. Preferably the wrench handle comprises a plurality of segments serially universally jointed. Preferably the handle comprises: a fore segment, the head being pivotally affixed to an end of the fore segment, an aft segment, a universal joint serially connecting the segments together, a grip at an end of the second segment distal from the joint by which a user applies axial torque to the second segment.

### BRIEF DESCRIPTION OF THE DRAWINGS

FIG. 1 is a full length pictorial view of the invention.

FIG. 2 is a partial pictorial view of the invention illustrating an intermediately disposed universal articulation of the wrench's handle from an angle different from FIG. 1.

FIG. 3 is a partial pictorial view of the invention detailing the head portion of the wrench.

FIG. 4 is a partial pictorial view of the invention detailing the intermediately disposed universal articulation of the wrench's handle.

FIG. 5 is a partial pictorial view of the invention detailing a handle length adjustment feature of the invention.

### DESCRIPTION OF THE PREFERRED EMBODIMENT

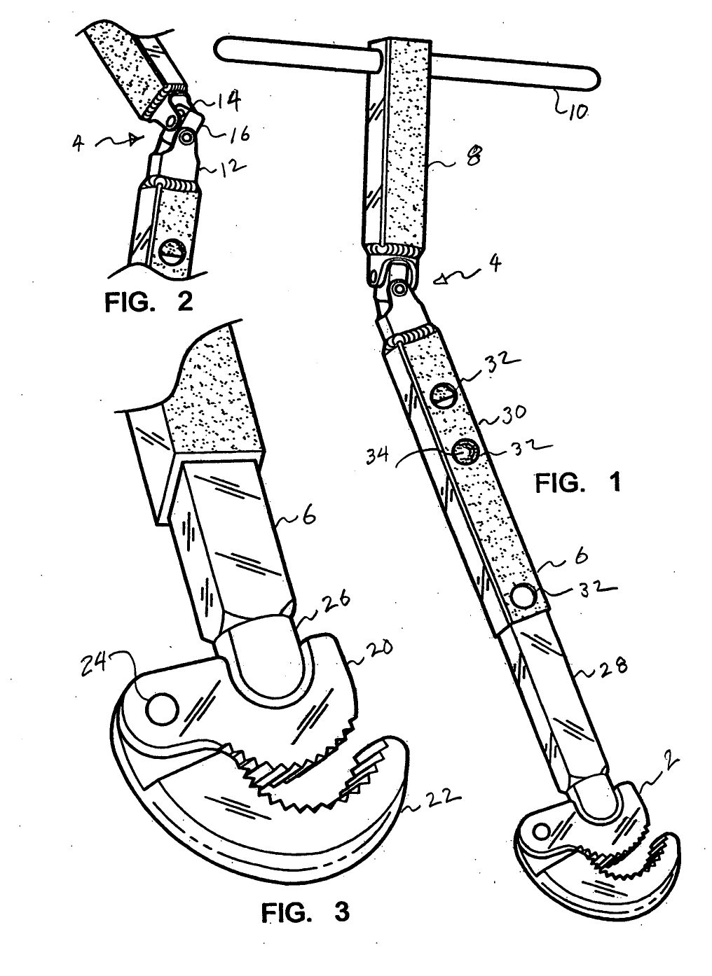

Referring to FIG. 1, the wrench of this invention is illustrated to include a pivoting head 2 with jaws for engaging an item being wrenched, a universal articulation, generally designated 4, illustrated as an integral universal joint, an elongated handle that when rotated axially wrenchingly turns the head about an item being wrenched, the handle including a fore segment 6 and an aft segment 8, and a gripping element by which a user axially rotates illustrated herein as a T-bar 10 protruding through an end of the handle distal from the head for axially rotating the aft segment 8. In operation, a user employs the T-bar as a lever to apply axial torque to the aft segment to rotate it and the rotational torque is communicated axially to the fore segment via the articulation. This causes the fore segment to rotate accordingly and apply wrenching torque to the head. The articulation allows the torque to be communicated from the aft to the fore segments while they are in any angled disposition, relative to each other, over a broad conical range of space the apex of which is at the articulation.

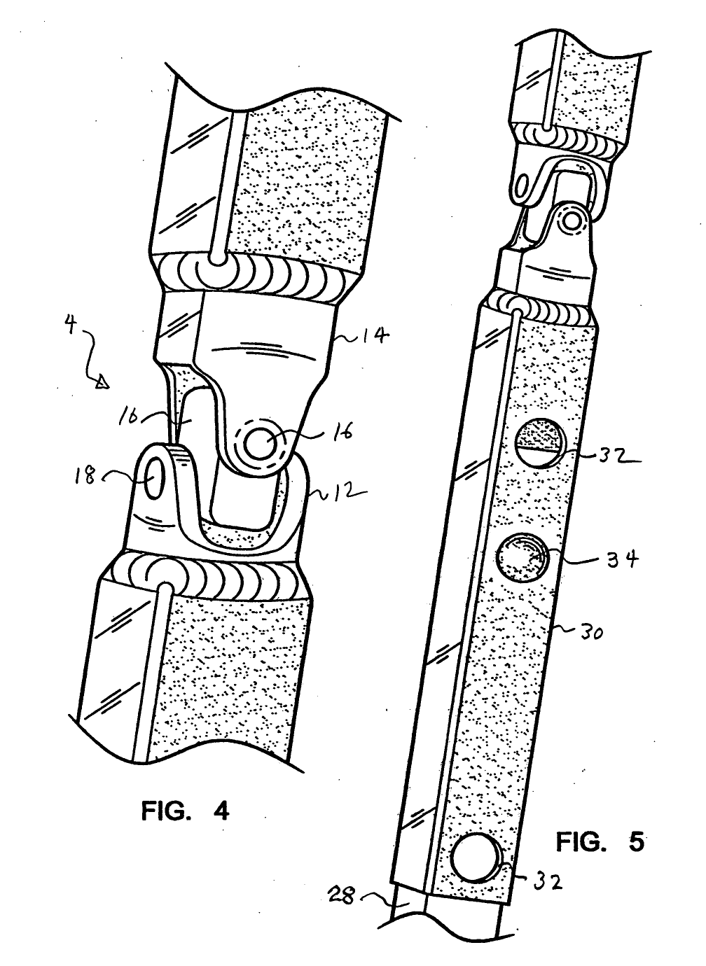

Referring to FIGS. 2 and 4, the serial (end-to-end) joining of the handle segments by the integrated articulation 4 is illustrated in greater detail. Affixed to opposing ends of the fore and aft segments are respective, opposing clevises, 12 and 14. The devises are axially offset from each other by generally ninety degrees and are pivotally coupled together by a generally parallelepiped block 16. Opposite ends of the block are pivotally affixed in respective devises by means of pivot pins, 16 and 18. In operation, the block's pivotal axes are normal to each other allowing each segment to be axially rotated while maintaining a selected angular relationship.

Referring to FIG. 3, the head of the wrench is illustrated to include two opposal jaws, 20 and 22, a first jaw pivotally affixed to a head end 26 of the fore segment 6 of the handle, a second jaw pivotally affixed to the first by a pivot pin 24. Preferably the jaws are biased closed by a spring (not shown). As with conventional basin wrenches, the jaws are matingly curved to fit a range of nuts and include opposing serrations to grip a nut.

Referring to FIGS. 1 and 5, preferably the fore segment can be adjusted in length, and so includes a first rectangularly cross-sectioned tube 28 slidingly disposed in a second rectangularly cross-sectioned tube 30, and a series of holes 32 defined in one wall of the second tube for catching a resiliently depressable button 34 projecting from a corresponding wall of the first tube. When the button is depressed the first tube can slide along the second tube until the button aligns with one of the holes 32 at which time it will pop up through the hole and catch the first tube to prevent any further sliding of same.

Although the embodiment described above has a length adjustable fore segment, it should be understood that the scope of this invention includes embodiments wherein the aft segment is adjustable in length, and a further embodiment wherein both segments are adjustable in length, and a further embodiment wherein none of the segments are adjustable in length.

It should also be noted that the relative lengths of the fore and aft segments can be different that illustrated without being outside the scope of this invention. That is, the disposition of the articulation along the handle can change according to need.

The foregoing description and drawings were given for illustrative purposes only, it being understood that the invention is not limited to the embodiments disclosed, but is intended to embrace any and all alternatives, equivalents, modifications and rearrangements of elements falling within the scope of the invention as defined by the following claims.

I claim:

1. A wench comprising:
(a) a head including jaws for engaging an item being wrenched; and
(b) a handle that when rotated axially wrenchingly turns the head about said item, the handle being universally articulated intermediate the head and a distal end of the handle.

2. The wrench according to claim 1 wherein the handle is telescopically adjustable in length.

3. The wrench according to claim 1 wherein the handle comprises a plurality of segments serially universally jointed.

4. The wrench according to claim 3 further comprising a segment that is telescopically adjustable in length.

5. A wench comprising:
(a) a head including jaws for engaging an item being wrenched; and
(b) a handle that when rotated axially wrenchingly turns the head about said item, the handle comprising:
(1) a fore segment, the head being pivotally affixed to an end of the fore segment,
(2) an aft segment,
(3) a universal joint serially connecting the segments together,
(4) a grip at an end of the second segment distal from the joint by which a user applies axial torque to the second segment.

6. For a basin-type wrench an improvement comprising a handle universally articulated intermediate the head and a distal end of the handle.

7. The wrench according to claim 6 wherein the handle comprises a plurality of segments serially universally jointed.

8. The wrench according to claim 7 further comprising a segment that is telescopically adjustable in length.
